(19) United States
(12) Patent Application Publication
(10) Pub. No.: US 2023/0144144 A1
(43) Pub. Date: May 11, 2023

(54) WATER ACCELERATOR

(71) Applicant: Aquateq Development, Copenhagen K (DK)

(72) Inventor: Rune Shik NEUMANN, Hammel (DK)

(73) Assignee: Aquateq Development, Copenhagen K (DK)

(21) Appl. No.: 17/907,817

(22) PCT Filed: Feb. 26, 2021
(86) PCT No.: PCT/DK2021/050059

§ 371 Date: Aug. 29, 2022

(30) Foreign Application Priority Data
Feb. 28, 2020 (DK) PA202070129

(51) Int. Cl. F15D 1/02

(52) U.S. Cl. CPC F15D 1/025

(57) ABSTRACT

A water accelerator with a body and a channel extending along an axis X through the body from a water inlet to a water outlet. The channel includes an inlet section having a first substantially constant diameter D1. The inlet section connects directly to an acceleration section. The acceleration section has diameter D2 decreasing in the flow direction. The acceleration section connects directly or via a constant diameter section to an action section. The action section has a diameter D4 increasing in the flow direction. The increase of the diameter D4 of the action section starts gradually. An air admission channel extends through the body from the exterior of the body to the action section and/or to a section of the channel subsequent to the action section in the flow direction.

### TECHNICAL FIELD

The disclosure relates to, a water accelerator and more particularly to a water accelerator that increases the speed of a flow of water supplied to an inlet of the water accelerator to a higher speed of the water at an outlet of the water accelerator.

### BACKGROUND

In many applications, such as a showerhead, or spray nozzle for fire extinguishing systems, or jet nozzles for fire extinguishing and other purposes, such as irrigation, it is an advantage that the water leaves the device at a high speed. The high-speed allows increases the effectiveness of e.g. a showerhead or a spray nozzle for fire extinguishing systems and increases the range of the water jet that is used for firefighting or irrigation.

CN202901439U discloses an air-pressurizing water-saving faucet with a body, a channel extending along an axis through the body from a water inlet to a water outlet (14), the channel comprises an inlet section open to the water inlet, the inlet section having a first substantially constant diameter, the inlet section connects directly to an acceleration section, the acceleration section having diameter decreasing in a flow direction from the water inlet to the water outlet, the acceleration section connecting via a constant diameter section to an action section, the action section having a diameter increasing in the flow direction, and an air admission channel extending through the body from the exterior of the body to the action section. The angle at which the action section widens is not sufficient for obtaining substantial acceleration, and the sudden increase in diameter from the constant diameter section to the action section hampers effective acceleration.

### SUMMARY

It is an object to provide a water accelerator that effectively increases the speed of the jet or spray of water at the outlet of the water accelerator.

The foregoing and other objects are achieved by the features of the independent claim. Further implementation forms are apparent from the dependent claims, the description, and the figures.

According to a first aspect, there is provided a water accelerator, the water accelerator comprises a body, a channel extending along an axis X through the body from a water inlet to a water outlet, the channel comprises an inlet section open to the water inlet, the inlet section having a first substantially constant diameter D1, the inlet section connects directly to an acceleration section, the acceleration section having diameter D2 decreasing in a flow direction from the water inlet to the water outlet, the acceleration section connecting directly or via a constant diameter section to an action section, the action section having a diameter D4 increasing in the flow direction, the increase of the diameter D4 of the action section starting gradually, and an air admission channel extending through the body from the exterior of the body to the action section and/or to a section of the channel subsequent to the action section in the flow direction, wherein an angle α between the inner surface of the action section and the axis X is 40° to 80°.

By providing a combination of a gradually increasing transition into the action section, together with an admission channel that feeds into the action section or any subsequent section of the channel, the speed of the resulting waterjet is increased significantly compared to a Venturi arrangement or other prior art arrangements for increasing the speed of the water. The configuration results in a significant increase in the amount of air included in the resulting yet, which in turn results in a significantly increased speed of the resulting yet. Tests have shown that up to 600% (by volume) air is included in the resulting yet with the water accelerator according to the first aspect. By comparison, prior art water accelerators are typically not able to include more than 25% (by volume) air in the resulting jet.

According to a possible implementation of the first aspect, the transition from the acceleration section to the action section or from the constant diameter section to the action section (8) is a rounded transition. By making the transition rounded, a convex surface is created to which the waterjet attempts to adhere, thereby widening the waterjet.

According to a possible implementation of the first aspect, the increase of the diameter D4 of the action section starts gradually from a diameter equal to the diameter of the constant diameter section. This ensures an optimal acceleration effect.

According to a possible implementation of the first aspect, the action section forms an inner surface that diverges in the flow direction, preferably a conical inner surface, and wherein the air admission channel is a preferably straight bore that opens to the inner surface, preferably at a substantially right angle to the inner surface at the position where the channel opens into the inner surface.

According to a possible implementation of the first aspect an angle α between the inner surface of the action section and the axis X 50° to 70°, preferably 55° to 65°.

According to a possible implementation of the first aspect, the air admission channel opens to the action section at an angle γ with the axis X, the angle γ preferably being between 10° and 50°, more preferably between 20° and 40° or most preferably between 25° and 35°.

According to a possible implementation of the first aspect, the channel comprises an outlet section with a substantially constant diameter D5, the outlet section connecting directly to the action section, and the diameter D4 of the action section at the transition between the action section and the outlet section being substantially equal to the substantially constant diameter D5.

According to a possible implementation of the first aspect, the air admission channel (10) opens into the channel at the transition between the action section (8) and the outlet section (9)

According to a possible implementation of the first aspect, the air admission channel opens to the action section (8) in the downstream half part of the action section.

According to a possible implementation of the first aspect, the water accelerator is an insert, preferably an insert for inserting into a pipe fitting, water tubing, a showerhead, or a spray nozzle.

According to a possible implementation of the first aspect, the body has a substantially cylindrical outline and is provided with a circumferential recess that connects to the air admission channel.

According to a possible implementation of the first aspect, the body is provided with two circumferential grooves for receiving a gasket such as e.g. an O-ring, with the circumferential recess being disposed between the two circumferential grooves.

According to a possible implementation of the first aspect, the channel extends along the axis X through the body from a water inlet at a first side of the body to a water outlet at a second side of the body, the second side being opposite to the first side.

According to a possible implementation of the first aspect, the constant diameter section extends at a slight angle with the axis X.

According to a possible implementation of the first aspect, the body is made of a plastic material, preferably a plastic material that is approved for contact with water or foodstuff such as acrylic butadiene plastic, or homo- or copolymers of POM (polyoxymethylene). According to the second aspect, there is provided a water accelerator, the water accelerator comprising a body, a channel extending along an axis X through the body from a water inlet to a water outlet, the channel comprising an inlet section open to the water inlet, the inlet section having a first substantially constant diameter D1, the inlet section connects directly to an acceleration section, the acceleration section having diameter D2 decreasing in a flow direction from the water inlet to the water outlet, the acceleration section connecting directly or via a constant diameter section to an action section, the action section having a diameter D4 increasing in the flow direction, the increase of the diameter D4 of the action section starting gradually, and an air admission channel (10) extending through the body from the exterior of the body to the action section and/or to a section of the channel subsequent to the action section in the flow direction.

According to a third aspect, there is provided an assembly of a showerhead and a water accelerator according to the first or second aspect or any possible implementations thereof, the water accelerator being placed between an inlet of the showerhead and the spray nozzles of the showerhead.

According to a fourth aspect, there is provided an assembly of a spray- or jet nozzle and a water accelerator according to the first or second aspect or any possible implementations thereof, the water accelerator being placed between an inlet of the spray- or jet nozzle and an outlet of the spray- or jet nozzle.

These and other aspects will be apparent from and the embodiment(s) described below.

### BRIEF DESCRIPTION OF THE DRAWINGS

In the following detailed portion of the present disclosure, the aspects, embodiments, and implementations will be explained in more detail with reference to the example embodiments shown in the drawings, in which:

FIG. 1 is an elevated view of a water accelerator according to an embodiment,

FIG. 2 is a side view of the water accelerator of FIG. 1, and

FIG. 3 is a side view of another embodiment of a water accelerator.

### DETAILED DESCRIPTION

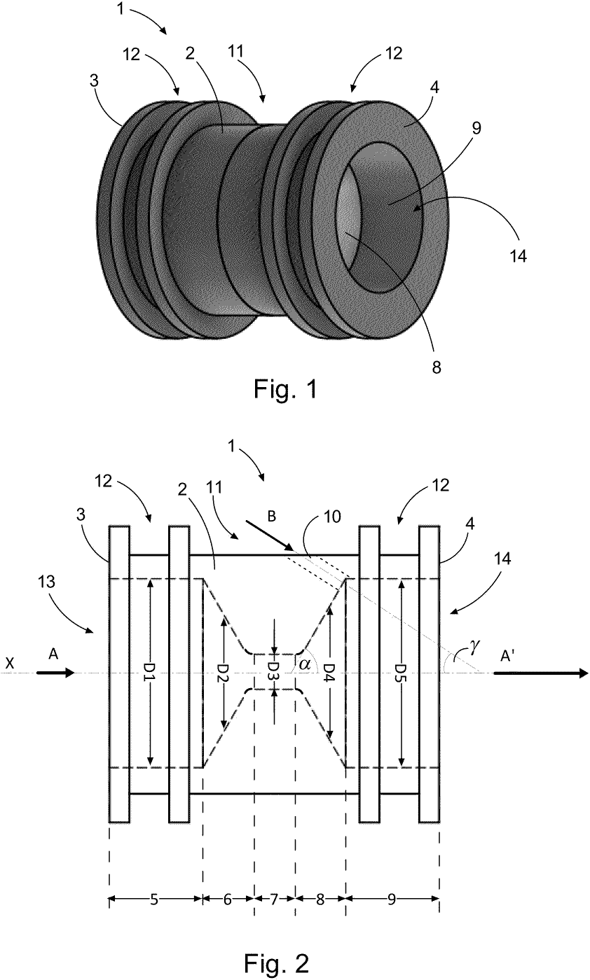

FIGS. 1 and 2 show a water accelerator 1, with a body 2. A channel extending along an axis X through the body 2 from a water inlet 13 on a first side 3 of the body 2 to a water outlet 14 on the opposite second side 4 of the body 2. The water inlet is intended to be connected to a source of pressurized water, such as the water supply system in the building. The outlet is intended to be connected to subsequent equipment e.g. a hose, a pipe, shower head, a jet nozzle, or a spray nozzle.

The channel has an inlet section 5 open to the water inlet 13. The inlet section 5 has a first substantially constant diameter D1 to form an inlet chamber. In the chamber, the water has a relatively low speed. The inlet section 5 connects directly to an acceleration section 6.

The acceleration section 6 has diameter D2 decreasing in a flow direction from the water inlet 13 to the water outlet 14, i.e. along the axis X. The decrease in the diameter D2 can be quite abrupt, although it is preferred that at least the transition from the acceleration section 6 to the next section of the channel, in this embodiment to a constant diameter section 7 is rounded to avoid cavitation. In the present embodiment, the acceleration section 6 connects directly to a constant diameter section 7.

The constant diameter section 7 is shown to be completely parallel with the main axis X, it is understood that the constant diameter section 7 may be arranged at a slight angle to the main axis X.

The constant diameter section 7 connects directly to an action section 8. The action section 8 has a diameter D4 that generally increases in the flow direction. In the shown embodiment the increase of the diameter D4 of the action 8 section starting gradually, to form a convex surface at the transition from the constant diameter section 7 to the action section 8, i.e. a rounded transition.

The action section 8 forms an inner surface that diverges in the flow direction, preferably a conical inner surface. An angle α between the conical inner surface of the action section 8 and the axis X is 40° to 80°, preferably 50° to 70° or more preferred 55° to 65°.

The channel comprises an outlet section 9 with a substantially constant diameter D5. The outlet section 9 connects directly to the action section 8 and the diameter D4 of the action section 8 at the transition between the action section 8 and the outlet section 9 is substantially equal to the substantially constant diameter D5.

An air admission channel 10 extends through the body 2 from the exterior of the body 2 to the action section 8 and/or to the section of the channel subsequent to the action section 8 in the flow direction (in this embodiment the outlet section 9). In the present embodiment, the air admission channel 10 opens into the channel at the transition between the action section 8 and the outlet section 9.

The air admission channel 10 is in this embodiment straight, but it is understood that the air admission channel 10 can be curved or angled bore. The air admission channel 10 to the inner surface at a substantially right angle to the inner surface at the position where the channel opens into the inner surface of the channel.

The air admission channel 10 opens to the channel at an angle γ with the axis X, the angle γ preferably being between 10° and 50°, more preferably between 20° and 40°, or most preferably between 25° and 35°.

The air admission channel 10 extends through the wall of the housing 1 in the radially inward direction. In the present embodiment, a single air admission channel is shown, but it is understood that the water accelerator 1 can be provided with a plurality of air admission channel 10.

The body 2 has a substantially cylindrical outline and is provided with a circumferential recess 11 that connects to the air admission channel 10. The body 1 is provided with two circumferential grooves 13 for receiving gasket like an O-ring or the like. The the circumferential recess 11 is disposed between the two circumferential grooves. Thus, the body 2 can be inserted into a cylindrical bore of e.g. a pipefitting such as e.g. a nipple, with the O-rings sealing against the inner wall of the cylindrical bore. The recess 11 between the O-rings is thus sealed off from and by providing an air inlet channel in the pipefitting that connects to the recess 11, ambient air can be supplied to the water accelerator 1 for admission into the action section 8.

The body may be provided with internal or external threading, to allow attachment to upstream equipment and/or downstream equipment, such as e.g. piping, processing equipment, water delivering equipment, e.g. showerheads, faucets, or the like used in plumbing installations.

The diameter of the inlet section 5 and the diameter of the optional outlet section 9 depends on the size of the piping to which the water accelerator 1 is to be connected.

The body 2 is preferably made of a plastic material, which is approved for contact with water or approved for contact with foodstuff, e.g. ABS acrylic butadiene plastic or homo- or copolymers of POM polyoxymethylene. Particularly preferred is POM, because it has good properties, especially in relation to strength and hardness, which allow the tubular member to be provided with threads or which can provide a tight connection without needing to apply other packing rings, discs or the like packing members between other members, e.g. metal members of a pipe and a pipe fitting, adapter or the like.

In the shown embodiment the water accelerator 1 is an insert for inserting into a pipe fitting, a showerhead, a jet nozzle, or a spray nozzle. The insert can be used to retrofit in an existing installation. Thus, may be necessary to provide an air vent in an existing pipe or adapter, showerhead, etc. in which the insert is arranged, to allow the air inlet to aspirate air from the surroundings.

The water accelerator insert forms an assembly with a showerhead, with the water accelerator insert being placed between an inlet of the showerhead and the spray nozzles of the showerhead.

The water accelerator insert forms an assembly with a spray nozzle or a jet nozzle with the water accelerator insert being placed between an inlet of the spray or jet nozzle and an outlet of the spray or jet nozzle.

A flow of water, e.g. supplied at a preferably substantially constant pressure by a conduit from a source of water is delivered to the inlet section 5. The source of pressurized water could be a pump or a water supply network. In the inlet section 5, the water has a substantially constant speed and pressure, the pressure corresponding substantially to the supply pressure. The converging nature of the acceleration section 6 increases the speed of the water and simultaneously decreases the pressure. Thus, the speed of the water when leaving the acceleration section 6 is significantly higher than the speed of the water in the inlet section 5. The ratio between the speed of the water in the inlet section 5 and the speed of the water when leaving the acceleration section 5 is equal to the ratio between the diameter D2 at the end of the acceleration section 6 and the diameter D1 of the inlet section 5. The speed and pressure of the water in the constant diameter section 7 remain substantially constant.

When entering the action section 8 a water jet is formed. This water jet attempts to stay attached to the convex surface of the start of the action section 8, due to a physical phenomenon. This physical phenomenon is the tendency of a fluid jet to stay attached to a convex surface. This tendency to stay attached to a convex surface causes the water jet to widen in the action section 8. The tendency of the fluid jet to stay attached to a convex surface in the action chamber creates a sleeve of low pressure around the waterjet. This low pressure in the action section 8 around the waterjet aspirates ambient air into the action chamber through the air admission channel 10.

The flow of air that is thus aspirated into the action section 8 increases the speed of the water leaving the action section 8. Thus, although the widening of the water jet in the action section 8 would normally have caused a minor decrease in velocity of the water, this decrease is at least partially offset by the stream of air into the action section 8 (or into a section subsequent to the action section 8). Consequently, the water largely maintains its velocity after entering the action section 8 and leaves the action section 8 with a higher speed and compared to a situation where there is no stream of air into the action section 8 through an air admission channel 10. Tests have been performed in which the word accelerator 1 supplied with water at a constant pressure and all other factors remaining unchanged, with the only change being the opening and closing of the air admission channel 10. With the air admission channel 10 open the range of the resulting waterjet is significantly larger than with the air admission channel closed.

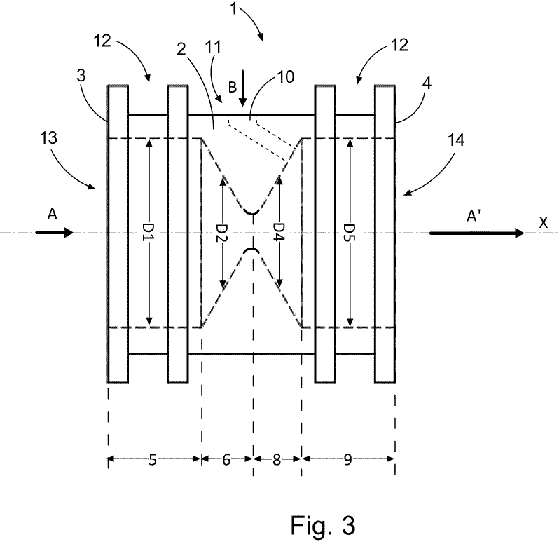

FIG. 3 shows another embodiment of the water accelerator 1. In this embodiment, structures and features that are the same or similar to corresponding structures and features previously described or shown herein are denoted by the same reference numeral as previously used for simplicity. The embodiment of FIG. 3 is essentially identical to the embodiment of FIGS. 1 and 2, except that the embodiment of FIG. 3 does not have a constant diameter section, so that the acceleration section 6 directly connects to the action section 8. The transition between the acceleration section 6 and the action section 8, is rounded, to ensure that the waterjet attempts to follow the convex surface at the start of the action section 8, thereby widening the water jet. Further, the air admission channel 10 opens into the diverging inner wall of the action section 8, in the downstream half part of the action section 8. In this embodiment the diverging inner wall of the action section 8 is conical. Preferably, the air admission channel 10 opens into the inner wall of the action section at an essentially right angle to an inner surface around the opening.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

The reference signs used in the claims shall not be construed as limiting the scope. Unless otherwise indicated, the drawings are intended to be read e.g., cross-hatching, arrangement of parts, proportion, degree, etc. together with the specification, and are to be considered a portion of the entire written description of this disclosure.

1. A water accelerator, said water accelerator comprising:
a body,
a channel extending along an axis X through said body from a water inlet to a water outlet,
said channel comprising:
an inlet section open to said water inlet, said inlet section having a first substantially constant diameter D1,
said inlet section connects directly to an acceleration section,
said acceleration section having diameter D2 decreasing in a flow direction from said water inlet to said water outlet,
said acceleration section connecting directly or via a constant diameter section to an action section,
said action section having a diameter D4 increasing in said flow direction,
the increase of the diameter D4 of said action section starting gradually, and
an air admission channel extending through said body from the exterior of said body to said action section and/or to a section of said channel subsequent to said action section in said flow direction, characterized in that an angle α between the inner surface of the action section and said axis X is 40° to 80°.

2. The water accelerator according to claim 1, wherein the transition from said acceleration section to said action section or wherein the transition from said constant diameter section to said action section is a rounded transition.

3. The water accelerator according to claim 1, wherein said action section has an inner surface that diverges in said flow direction, preferably a conical inner surface, and wherein said air admission channel is a preferably straight bore that opens to said inner surface, preferably at a substantially right angle to said inner surface at the position where said air admission channel opens into said inner surface.

4. The water accelerator according to claim 1, wherein an angle α between the inner surface of the action section and said axis X is 50° to 70°, preferably 55° to 65°.

5. The water accelerator according to claim 1, wherein said air admission channel opens to said action section at an angle γ with said axis X, said angle γ preferably being between 10° and 50°, more preferably between 20° and 40° or most preferably between 25° and 35°.

6. The water accelerator according to claim 1 , wherein said channel comprises an outlet section with a substantially constant diameter D5, said outlet section connecting directly to said action section and the diameter D4 of said action section at the transition between said action section and the outlet section being substantially equal to said substantially constant diameter D5.

7. TheA water accelerator according to claim 6, wherein said air admission channel opens into said channel at the transition between said action section and said outlet section.

8. The water accelerator according to claim 1, wherein said air admission channel opens to said action section in the downstream half part of the action section.

9. TheA water accelerator according to claim 1 , wherein said water accelerator is an insert, preferably an insert for inserting into a pipe fitting, a showerhead, or a spray nozzle.

10. The water accelerator according to claim 1 , wherein said body has a substantially cylindrical outline and is provided with a preferably circumferential recess that connects to said air admission channel.

11. The water accelerator according to claim 9, wherein said body is provided with two circumferential grooves for receiving a gasket, with said circumferential recess being disposed between said two circumferential grooves.

12. The water accelerator according to claim 1 , wherein the increase of the diameter D4 of the action section starts gradually from a diameter equal to the diameter of the constant diameter section.

13. A water accelerator, said water accelerator comprising:
a body,
a channel extending along an axis X through said body from a water inlet to a water outlet,
said channel comprising:
an inlet section open to said water inlet, said inlet section having a first substantially constant diameter D1,
said inlet section connects directly to an acceleration section,
said acceleration section having diameter D2 decreasing in a flow direction from said water inlet to said water outlet,
said acceleration section connecting directly or via a constant diameter section to an action section,
said action section having a diameter D4 increasing in said flow direction,
the increase of the diameter D4 of said action section starting gradually, and
an air admission channel extending through said body from the exterior of said body to said action section and/or to a section of said channel subsequent to said action section in said flow direction.
